(19) United States
(12) Patent Application Publication
(10) Pub. No.: US 2026/0296948 A1
(43) Pub. Date: Oct. 1, 2026

(54) HOLLOW-CORE PREFORMS AND HOLLOW-CORE OPTICAL FIBERS AND METHODS OF MAKING THE SAME

(71) Applicant: CORNING INCORPORATED, CORNING, NY (US)

(72) Inventors: David Alan Deneka, Corning, NY (US); Riley Saunders Freeland, Corning, NY (US)

(21) Appl. No.: 19/571,740

(22) Filed: Mar. 19, 2026

Related U.S. Application Data
(60) Provisional application No. 63/777,028, filed on Mar. 25, 2025.

(51) Int. Cl. C03B 37/018; C03B 37/012

(52) U.S. Cl. CPC C03B 37/018; C03B 37/0122; C03B 37/01222; C03B 2203/16

(57) ABSTRACT

A hollow-core preform including a preform longitudinal axis may include: an outer tube disposed around the preform longitudinal axis and having an inner surface defining an interior cavity, and an inner tube disposed inside the interior cavity of the outer tube. The inner tube may include an inner tube longitudinal axis offset from the preform longitudinal axis and an outer surface. In some embodiments, the outer surface of the inner tube may be bonded to the inner surface of the outer tube along at least a middle portion or an entirety of a length of the inner tube, and a distance between the inner surface of the inner tube and the outer surface of the outer tube at the location of bonding may substantially correspond to a combined thickness of the inner tube and the outer tube.

### CROSS-REFERENCE TO RELATED APPLICATIONS

This application claims the benefit of priority of U.S. Application No. 63/777,028 filed on Mar. 25, 2025, the content of which is relied upon and incorporated herein by reference in its entirety.

### FIELD

The present disclosure generally relates to optical fibers, and more specifically, to methods for producing hollow-core preforms for producing hollow-core optical fibers.

### BACKGROUND

Hollow-core optical fiber is an emerging product that is gaining attention due to its potentially low attenuation and very low latency. The internal microstructure of the hollow-core optical fiber is unique in that the light travels through the air in the fiber, bound by structural features or cladding elements in the fiber defining the hollow core. There are many varieties of the cladding elements, such as round capillaries, nested capillaries, etc. The microstructure of the hollow-core optical fiber, such as dimensions and/or locations of the cladding elements, are important because it dictates how well light will travel down the fiber. Accordingly, there is a need to produce hollow-core optical fibers and hollow-core preforms for drawing the fiber with ease and precision.

### SUMMARY

In some embodiments, a hollow-core preform may include a preform longitudinal axis, an outer tube disposed around the preform longitudinal axis, and an inner tube disposed inside an interior cavity of the outer tube. In some embodiments, the outer tube may include an inner surface defining the interior cavity through which the preform longitudinal axis may extend, and an outer surface. In some embodiments, the inner tube may include an inner tube longitudinal axis offset from the preform longitudinal axis, an inner surface disposed around the inner tube longitudinal axis, an outer surface, a first end, a second end opposite the first end, and a length extending between the first end and the second end. In some embodiments, the hollow-core preform may further include soot particles. In some embodiments, the outer surface of the inner tube may be bonded to the inner surface of the outer tube by the soot particles. In some embodiments, the outer surface of the inner tube may directly contact the inner surface of the outer tube, and the outer surface of the inner tube may be bonded to the inner surface of the outer tube on either side of the direct contact by at least some of the soot particles. In some embodiments, at least some of the soot particles may be disposed on a portion of the outer surface of the inner tube facing away from the outer tube.

In some embodiments, a hollow-core preform may include a preform longitudinal axis, an outer tube disposed around the preform longitudinal axis, and an inner tube disposed inside an interior cavity of the outer tube. In some embodiments, the outer tube may include an inner surface defining the interior cavity through which the preform longitudinal axis extends, an outer surface; and a thickness defined by a distance between the inner surface and the outer surface that may be greater than or equal to 2 mm and less than or equal to 15 mm. In some embodiments, the inner tube may include an inner tube longitudinal axis offset from the preform longitudinal axis, an inner surface disposed around the inner tube longitudinal axis, an outer surface, a thickness defined by a distance between the inner surface and the outer surface that may be greater than or equal to 0.5 mm and less than or equal to 10 mm, a first end, a second end opposite the first end, and a length extending between the first end and the second end. In some embodiments, the outer surface of the inner tube may be bonded directly to the inner surface of the outer tube continuously along a majority of the length of the inner tube. In some embodiments, a distance between the inner surface of the inner tube and the outer surface of the outer tube at the location of bonding may substantially correspond to the thickness of the inner tube and the thickness of the outer tube combined.

In some embodiments, a method of making a hollow-core preform may include providing an outer tube, which may include an outer tube longitudinal axis, an inner surface defining an interior cavity through which the outer tube longitudinal axis extends, an outer surface, and a thickness defined by a distance between the inner surface and the outer surface. In some embodiments, the method may further include positioning an inner tube inside the interior cavity of the outer tube. In some embodiments, the inner tube may include an inner tube longitudinal axis offset from the outer tube longitudinal axis, an inner surface disposed around the inner tube longitudinal axis, an outer surface, a thickness defined by a distance between the inner surface and the outer surface, a first end, a second end opposite the first end, and a length between the first end and the second end. In some embodiments, the method may further include heating the outer tube, and bonding the outer surface of the inner tube to the inner surface of the outer tube continuously along a majority of the length of the inner tube. In some embodiments, after the outer surface of the inner tube is bonded to the inner surface of the outer tube, a distance between the inner surface of inner tube and the outer surface of the outer tube at the location of bonding substantially correspond to a combined thickness of the thickness of the inner tube and the thickness of the outer tube prior to bonding.

In some embodiments, a method of making a hollow-core preform may include providing an outer tube, which may include an outer tube longitudinal axis, an inner surface defining an interior cavity through which the outer tube longitudinal axis extends, an outer surface, and a thickness defined by a distance between the inner surface and the outer surface. In some embodiments, the method may further include positioning an inner tube inside the interior cavity of the outer tube. In some embodiments, the inner tube may include a first end, a second end opposite the first end, a length between the first end and the second end, an inner tube longitudinal axis extending from the first end to the second end and offset from the outer tube longitudinal axis, an inner surface disposed around the inner tube longitudinal axis, an outer surface, and a thickness defined by a distance between the inner surface and the outer surface. In some embodiments, the method may further include flowing one or more glass precursors into the interior cavity of the outer tube. In some embodiments, the method may further include heating the outer tube to cause the one or more glass precursors to form soot particles on at least one of the outer surface of the inner tube or the inner surface of the outer tube.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying figures.

FIG. 1A schematically illustrates a perspective view of an exemplary hollow-core optical fiber.

FIG. 1B schematically illustrates a cross-sectional view of the hollow-core optical fiber of FIG. 1A.

FIG. 1C schematically illustrates a cross-sectional view of another exemplary hollow-core optical fiber.

FIG. 2A schematically illustrates a perspective view of an exemplary hollow-core preform.

FIG. 2B schematically illustrates a cross-sectional view of the hollow-core preform of FIG. 2A.

FIG. 2C schematically illustrates a cross-sectional view of another exemplary hollow-core preform.

FIG. 3 schematically illustrates an exemplary process for producing a hollow-core preform.

FIG. 4 schematically illustrates exemplary fixtures for securing inner tubes in an interior cavity of an outer tube of a hollow-core preform.

FIG. 5 schematically illustrates another exemplary process for producing a hollow-core preform.

FIG. 6 schematically illustrates another exemplary process for producing a hollow-core preform.

FIG. 7 schematically illustrates soot particle deposition attaching inner tubes to an outer tube of a hollow-core preform using the process of FIG. 6.

FIG. 8 schematically illustrates an exemplary process for drawing a hollow-core optical fiber from a hollow-core preform.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

When terms, such as “circular,” “square,” “linear,” “parallel,” “perpendicular,” “tangential,” “symmetrical,” “congruent,” “identical,” “coaxial,” “concentric,” “equiangular,” “equidistant,” etc., are used to describe geometrical properties, it is understood that actual geometrical properties may vary or deviate from these precise conditions due to factors including, but not limited to, manufacturing limitations or tolerances, material properties, environmental conditions, measurement inaccuracies, and so on. Thus, while the terms imply precise geometric properties, practical application acknowledges and permits minor discrepancies.

Directional terms as used herein - for example up, down, right, left, front, back, top, bottom - are made only with reference to the figures as drawn and are not intended to imply absolute orientation.

Various components described herein may be referred to as “directly connected,” “directly attached,” “directly bonded,” “indirectly connected,” “indirectly attached,” or “indirectly bonded.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g., frits, solders, fluxes), adhesives, and bonding materials. The term “connected” means “directly connected” or “indirectly connected.” The term “attached” means “directly attached” or “indirectly attached.” The term “bonded” means “directly bonded” or “indirectly bonded.”

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Reference will now be made in detail to various embodiments. Whenever possible, the same reference numerals will be used throughout the drawings to refer to the same or like parts.

### Hollow-Core Optical Fiber

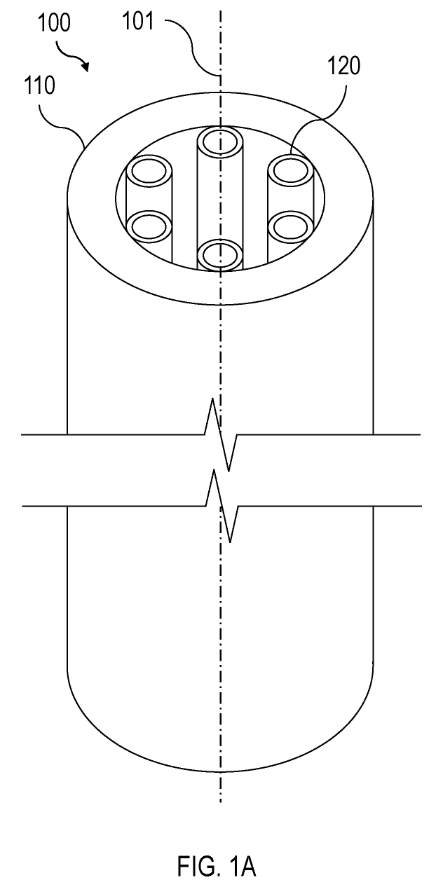

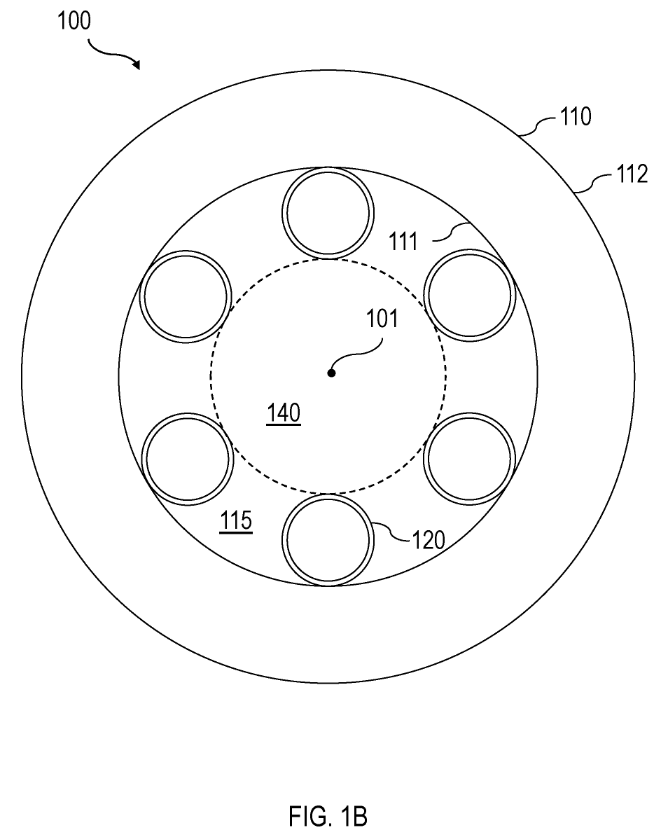

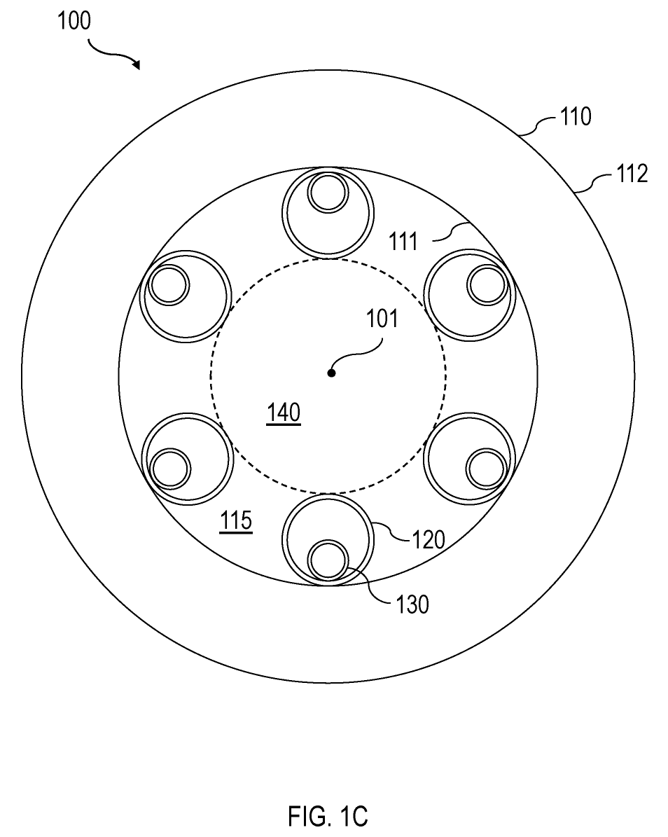

FIG. 1A schematically illustrates a perspective view of an example of a hollow-core optical fiber 100 having a longitudinal axis 101. FIG. 1B schematically illustrates a cross-sectional view of the hollow-core optical fiber 100. The hollow-core optical fiber 100 may include an outer cladding 110. The outer cladding 110 may include an inner surface 111 defining an interior cavity 115 and an outer surface 112. The hollow-core optical fiber 100 may further include one or more (e.g., one, two, three, four, five, six, or more) cladding elements, such as capillaries 120, inside the interior cavity 115 of the outer cladding 110. The capillaries 120 may be in contact with and/or attached to the inner surface 111 of the outer cladding 110. The capillaries 120 may not be in contact with each other and may be evenly spaced along the inner surface 111 of the outer cladding 110. In some embodiments, the cladding elements of the hollow-core optical fiber 100 may also include nested capillaries 130, such as shown in FIG. 1C. Each nested capillary 130 may be disposed inside a capillary 120 and in contact with and/or attached to an inner surface of the capillary 120. The cladding elements of the hollow-core optical fiber 100, e.g., the capillaries 120 and/or the nested capillaries 130, may surround and define a hollow core 140 of the hollow-core optical fiber 100. The hollow core 140 may be the central portion of the interior cavity 115 and may correspond to the region of the hollow-core optical fiber 100 in which optical signals may be primarily confined and propagate. In some embodiments, the outer cladding 110, the capillaries 120, and/or the nested capillaries 130 may include silica glass and/or silica-based glass (i.e., silica glass comprising one or more dopants).

### Hollow-Core Preform

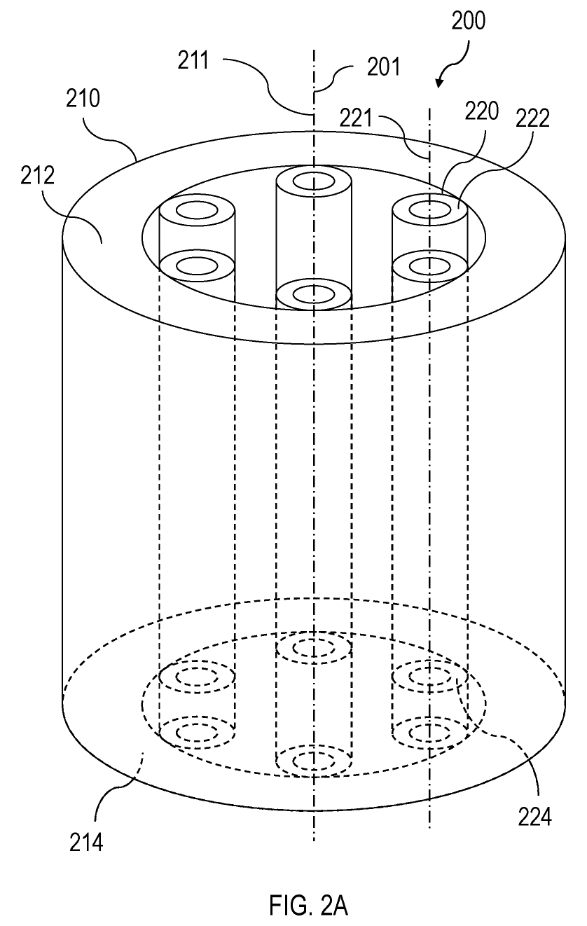

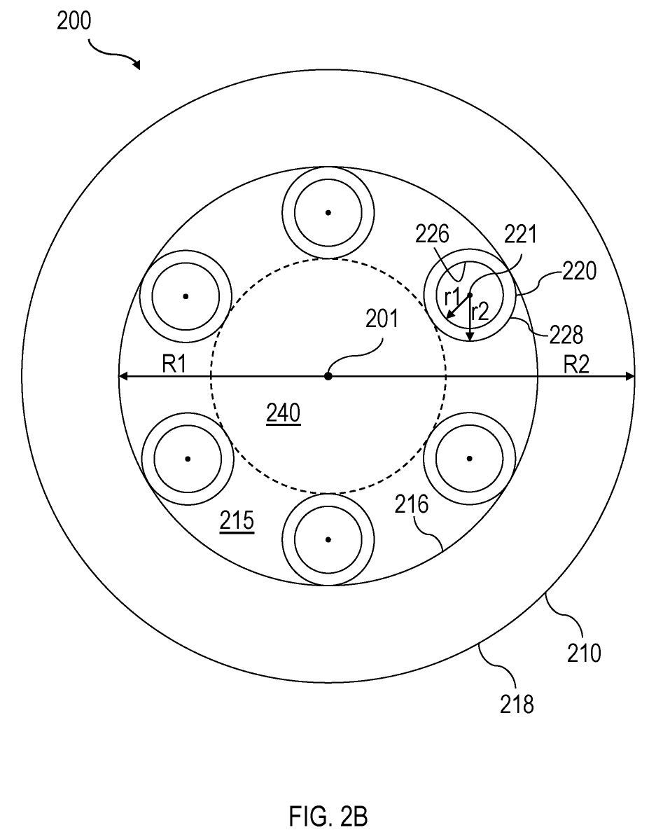

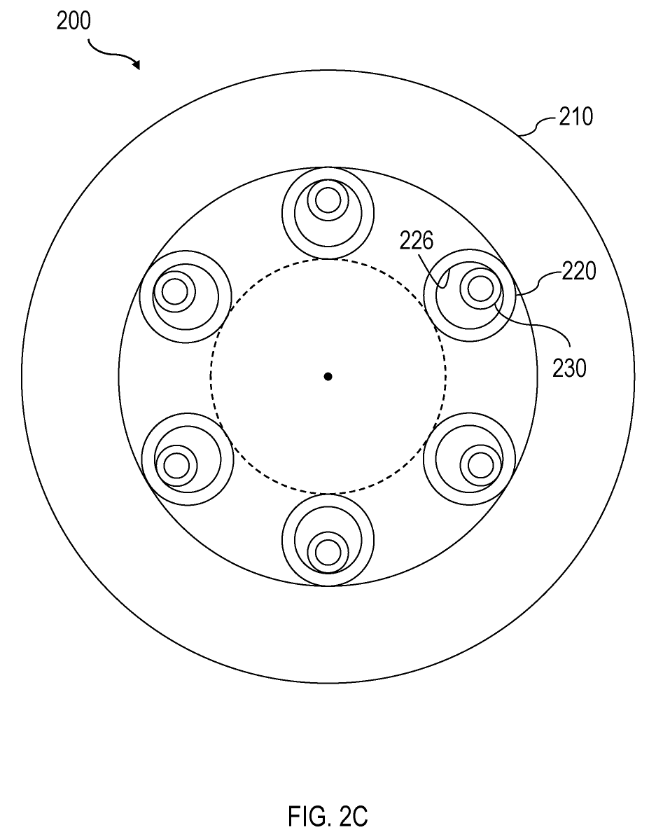

The hollow-core optical fiber 100 may be produced by drawing a hollow-core preform into fiber. FIG. 2A schematically illustrates a perspective view of an example of a hollow-core preform 200 that may be utilized for producing the hollow-core optical fiber 100 shown in FIG. 1A and 1B. FIG. 2B schematically illustrates a cross-sectional view of the hollow-core preform 200 of FIG. 2A.

In some embodiments, the hollow-core preform 200 may include a preform longitudinal axis 201 extending along the length of the hollow-core preform 200, and an outer tube 210 disposed around the preform longitudinal axis 201. In some embodiments, the outer tube 210 may include silica glass and/or silica-based glass (i.e., silica glass comprising one or more dopants).

The outer tube 210 may include a first end or end face 212, a second end or end face 214 opposite the first end 212, and a length extending between the first end 212 and the second end 214. The outer tube 210 may include an outer tube longitudinal axis 211 that may align with the preform longitudinal axis 201. The outer tube 210 may include an inner surface 216, an outer surface 218, and a thickness defined by a distance between the inner surface 216 and the outer surface 218. The inner surface 216 of the outer tube 210 may define an interior cavity 215 through which the outer tube longitudinal axis 211 and/or the preform longitudinal axis 201 extends. In some embodiments, the inner surface 216 and/or the outer surface 218 may be continuous surface(s). For example, in some embodiments, the inner surface 216 of the outer tube 210 may be continuous along an inner circumference of the outer tube 210 and/or along the entire length of the outer tube 210, and/or the outer surface 218 of the outer tube 210 may be continuous along an outer circumference of the outer tube 210 and/or along the entire length of the outer tube 210. The inner surface 216 and/or the outer surface 218 of the outer tube 210 may not include grooves.

In some embodiments, the outer tube 210 may be cylindrical. The outer tube 210 may have an inner radius R1, and thus, the inner surface 216 of the outer tube 210 may be disposed at a radial distance R1 from the outer tube longitudinal axis 211 and/or the preform longitudinal axis 201. The outer tube 210 may have an outer radius R2, and thus, the outer surface 218 of the outer tube 210 may be disposed at a radial distance R2 from the outer tube longitudinal axis 211 and/or the preform longitudinal axis 201. In some embodiments, the inner radius R1 may be greater than or equal to (i.e., ≥) 15 mm, ≥ 17 mm, ≥ 19 mm, ≥ 21 mm, ≥ 23 mm, or greater. In some embodiments, the inner radius R1 may be less than or equal to (i.e., ≤) 25 mm, ≤ 23 mm, ≤ 21 mm, ≤ 19 mm, ≤ 17 mm, or less. In some embodiments, the inner radius R1 may be greater than or equal to (i.e., ≥) 15 mm and less than or equal to (i.e., ≤) 25 mm – including all sub-ranges or values therebetween, for example, ≥ 15 mm and ≤ 25 mm, ≥ 15 mm and ≤ 20 mm, or ≥ 20 mm and ≤ 25 mm. In some embodiments, the outer radius R2 may be greater than or equal to (i.e., ≥) 25 mm, ≥ 27 mm, ≥ 29 mm, ≥ 31 mm, ≥ 33 mm, or greater. In some embodiments, the outer radius R2 may be less than or equal to (i.e., ≤) 35 mm, ≤ 33 mm, ≤ 31 mm, ≤ 29 mm, ≤ 27 mm, or less. In some embodiments, the outer radius R2 may be greater than or equal to (i.e., ≥) 25 mm and less than or equal to (i.e., ≤) 35 mm – including all sub-ranges or values therebetween, for example, ≥ 25 mm and ≤ 30 mm, or ≥ 30 mm and ≤ 35 mm. In some embodiments, the thickness of the outer tube 210, defined as the radial distance between the inner surface 216 and the outer surface 218 of the outer tube 210, i.e., R2 − R1, may be greater than or equal to (i.e., ≥) 2 mm, ≥ 4 mm, ≥ 6 mm, ≥ 8 mm, ≥ 10 mm, ≥ 12 mm, ≥ 14 mm, or greater. In some embodiments, the thickness of the outer tube 210 may be less than or equal to (i.e., ≤) 15 mm, ≤ 13 mm, ≤ 11 mm, ≤ 9 mm, ≤ 7 mm, ≤ 5 mm, ≤ 3 mm, or less. In some embodiments, the thickness of the outer tube 210 may be greater than or equal to (i.e., ≥) 2 mm and less than or equal to (i.e., ≤) 15 mm – including all sub-ranges or values therebetween, for example, ≥ 2 mm and ≤ 10 mm, ≥ 2 mm and ≤ 5 mm, ≥ 5 mm and ≤ 15 mm, ≥ 5 mm and ≤ 10 mm, or ≥ 10 mm and ≤ 15 mm.

With continued reference to FIGS. 2A and 2B, in some embodiments, the hollow-core preform 200 may further include one or more (e.g., one, two, three, four, five, six, or more) inner tubes 220 disposed inside the interior cavity 215 of the outer tube 210. In some embodiments, the inner tubes 220 may be in contact with and/or attached to the inner surface 216 of the outer tube 210 as will be discussed in more detail below. In some embodiments, the inner tubes 220 may not be in contact with each other and may be evenly spaced along the inner surface 216 of the outer tube 210. The inner tubes 220 may surround and define a hollow section 240 that may be the central portion of the interior cavity 215 and may correspond to the hollow core 140 of the hollow-core optical fiber 100 that may be produced using the hollow-core preform 200. In some embodiments, the inner tubes 220 may include silica glass and/or silica-based glass (i.e., silica glass comprising one or more dopants).

Each of the inner tubes 220 may include a first end or end face 222, a second end or end face 224 opposite the first end 222, and a length extending between the first end 222 and the second end 224. Each of the inner tubes 220 may include an inner tube longitudinal axis 221 that may be offset from and parallel to the inner tube longitudinal axis 211 and/or the preform longitudinal axis 201. Each of the inner tubes 220 may include an inner surface 226, an outer surface 228, and a thickness defined by a distance between the inner surface 226 and the outer surface 228. The inner surface 226 of each inner tube 220 may define an interior cavity through which the inner tube longitudinal axis 221 extends.

In some embodiments, each of the inner tubes 220 may be cylindrical. Each of the inner tubes 220 may have an inner radius r1, and thus, the inner surface 226 of the inner tube 220 may be disposed at a radial distance r1 from the inner tube longitudinal axis 221. Each of the inner tubes 220 may have an outer radius r2, and thus, the outer surface 228 of the inner tube 220 may be disposed at a radial distance r2 from the inner tube longitudinal axis 221. In some embodiments, the thickness of each inner tube 220, defined as the radial distance between the inner surface 226 and the outer surface 228 of the inner tube 220, i.e., r2 − r1, may be greater than or equal to (i.e., ≥) 0.5 mm, ≥ 1 mm, ≥ 3 mm, ≥ 5 mm, ≥ 7 mm, ≥ 9 mm, or greater. In some embodiments, the thickness of each inner tube 220 may be less than or equal to (i.e., ≤) 10 mm, ≤ 8 mm, ≤ 6 mm, ≤ 4 mm, ≤ 2 mm, ≤ 1 mm, or less. In some embodiments, the thickness of each inner tube 220 may be greater than or equal to (i.e., ≥) 0.5 mm and less than or equal to (i.e., ≤) 10 mm – including all sub-ranges or values therebetween, such as ≥ 0.5 mm and ≤ 7 mm, ≥ 0.5 mm and ≤ 3 mm, ≥ 3 mm and ≤ 10 mm, ≥ 3 mm and ≤ 7 mm, or ≥ 7 mm and ≤ 10 mm.

In some embodiments, such as shown in FIG. 2C, the hollow-core preform 200 may also include one or more nested tubes 230 with each disposed inside an inner tube 220 and in contact with and/or attached to the inner surface 226 of the inner tube 220. In some embodiments, the nested tubes 230 may include silica glass and/or silica-based glass (i.e., silica glass comprising one or more dopants).

### Producing Hollow-Core Preforms

To produce a hollow-core preform, such as the hollow-core preform 200, one or more smaller inner tubes of appropriate sizes and/or aspect ratios may be gathered inside a larger outer tube. Existing methods of assembling the hollow-core preform further includes attaching each inner tube to the outer tube near or at one or both ends of the inner tube using a sealing compound. It should be noted that in the existing methods, only a small portion along the length of the inner tube near or at either end of the inner tube is attached to the outer tube, and as only small, end portions of the inner tubes are attached to the outer tube, the inner tubes and the outer tube may become separated during subsequent handling. In the methods and/or processes described herein, the inner tubes may be attached to the outer tube along a greater portion of the length of the inner tubes, and may be attached to the outer tube along the entire length of the inner tubes in some embodiments, to achieve greater bonding between the inner tubes and the outer tube.

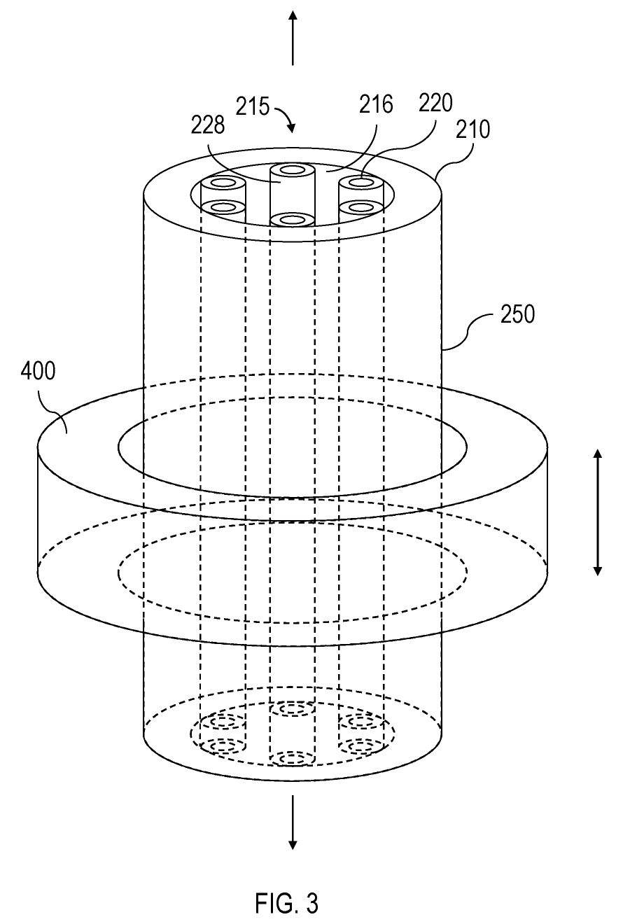

With reference to FIG. 3, an exemplary process for producing the hollow-core preform 200 is schematically shown. The process may include gathering the inner tubes 220 inside the interior cavity 215 of the outer tube 210 and placing the inner tubes 220 at the respective desired locations at the inner surface 216 of the outer tube 210 to form an intermediate assembly 250. The process may further include securing the inner tubes 220 to their respective locations. In some embodiments, the inner tubes 220 may be secured to their respective locations by attaching the inner tubes 220 to the outer tube 210 near or at either end of each inner tube 220 by flame welding, laser welding, or other suitable bonding techniques. In some embodiments, the inner tubes 220 may be secured to their respective locations using a sealing material at the interface of the inner tubes 220 and the outer tube 210 at or near either end of each inner tube 220.

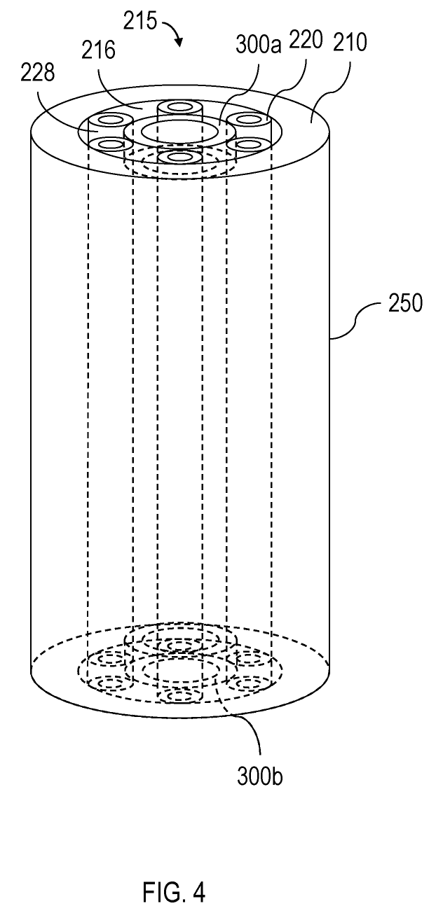

In some embodiments, the inner tubes 220 may be secured to the desired locations by a fixture that may be inserted into either end of the interior cavity 215 of the outer tube 210 to support and secure the inner tubes 220 at the desired locations. A non-limiting example of the fixture, more specifically, a pair of central support tubes 300a, 300b disposed at or near either end of the inner tubes 220, is shown in FIG. 4. The central support tubes 300a, 300b may be disposed radially inward from and surrounded by the inner tubes 220. In some embodiments, the fixture, such as the central support tubes 300a, 300b, may be configured to hold the inner tubes 220 such that the outer surfaces 228 of the inner tubes 220 may be brought to close proximity or may abut or directly contact the inner surface 216 of the outer tube 210, thereby limiting and/or preventing the relative movement between the inner tubes 220 and the outer tube 210. For example, in some embodiments, the fixture, such as the central support tubes 300a, 300b, may include a radial dimension, such as the outer diameter of the central support tubes 300a, 300b, that may be configured to form a tight fit between the central support tubes 300a, 300b and the surrounding inner tubes 220, which in turn may bring the inner tubes 220 in close proximity to the outer tube 210 and/or cause the inner tubes 220 to abut or directly contact the outer tube 210. In some embodiments, the fixture, e.g., the central support tubes 300a, 300b, may be attached to the outer surface 228 of each inner tube 220. Although a pair of cylindrical central support tubes 300a, 300b are described as an example of the fixture, fixtures of other form factors may be implemented for securing the inner tubes 220 to the outer tube 210. When the fixture is used, the inner tubes 220 may or may not be further attached or bonded to the outer tube 210 near or at the ends of the inner tubes 220.

After being secured to the outer tube 210 near or at the ends, in some embodiments, the inner tubes 220 may abut or directly contact the outer tube 210 along its entire length. For example, when the ends of the inner tubes 220 may be secured to the outer tube 210 via welding, the inner tubes 220 may also abut or directly contact the outer tube 210 along the portion of the length between the ends, e.g., the middle portion of the length, of each inner tube 220, and thus, may abut or directly contact the outer tube 210 along the entire length of each inner tube 220. Similarly, when the ends of the inner tubes 220 may be secured to the outer tube 210 using the fixture described herein, the inner tubes 220 may also abut or directly contact the outer tube 210 along the portion of the length between the ends of each inner tube 220, and thus, may abut or directly contact the outer tube 210 along the entire length of each inner tube 220. It should be noted that the abutting or direct contacting relationship described herein does not exclude gaps or spaces that may be formed between the inner tubes 220 and the outer tube 210 due to manufacturing variances or limitations, e.g., unevenness of the outer surface 228 of each inner tube 220 and/or the inner surface 216 of the outer tube 210. On the other hand, gaps or spaces may be formed or created between the inner tubes 220 and the outer tube 210 along the length of each inner tube 220 when a sealing material may be used for securing the ends of the inner tubes 220 to the outer tube 210 due to the presence of the sealing material at the interface of the inner tubes 220 and the outer tube 210. Thus, after being secured to the outer tube 210, the inner tubes 220 may be disposed inside the interior cavity 215 of the outer tube 210 such that the outer surface 228 of each inner tube 220 may abut or directly contact the inner surface 216 of the outer tube 210 along the lengths of the inner tubes 220 and/or outer tube 210, and/or may be in close proximity to the inner surface 216 of the outer tube 210 along the lengths of the inner tubes 220 and/or outer tube 210.

Once the intermediate assembly 250 is formed by securing the ends of the inner tubes 220 to the outer tube 210, the process may further include attaching the inner tubes 220 to the outer tube 210 along a greater portion of the length of each inner tube 220, such as along the portion of the length between the ends of each inner tube 220 and/or along the entire length of each inner tube 220. In some embodiments, the outer tube 210 and/or the inner tubes 220 may be heated to facilitate the attachment or bonding of the inner tubes 220 to the outer tube 210.

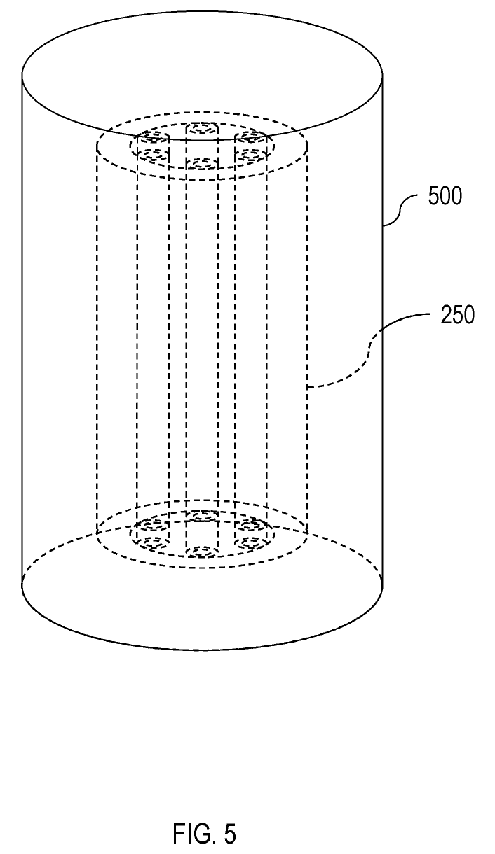

Referring back to FIG. 3, in some embodiments, the intermediate assembly 250 may be fed into a furnace having a heating zone 400. In some embodiments, the heating zone 400 may include an annular heating zone. In some embodiments, the heating zone 400 may include an axial dimension or length that may be less than the lengths of the inner tubes 220 and/or the outer tube 210. The intermediate assembly 250 and/or the heating zone 400 may be moved relative to each other to allow a greater portion of the length of outer tube 210 and/or the length of each inner tube 220 to be heated. For example, in some embodiments, the furnace may be configured to move the heating element for producing the heating zone 400 (discussed below) axially along the length of the intermediate assembly 250 while intermediate assembly 250 may be held in a static position. In some embodiments, the intermediate assembly 250 may be moved axially while the heating zone 400 may remain in a static position. In some embodiments, both the intermediate assembly 250 and the heating zone 400 may be moved. The relative movement between the heating zone 400 and the intermediate assembly 250 may allow the inner tubes 220 and/or the outer tube 210 to be heated along the entireties of their respective lengths. In some embodiments, a furnace having a heating zone 500 that may be greater than the length of the intermediate assembly 250 may be used, such as shown in FIG. 5.

In some embodiments, the heating zone 400, 500 may be created using a heating element. In some embodiments, the heating element may include a resistive heater, such as a resistive graphite cylinder or crucible, that may be heated using either direct current or alternating current. In some embodiments, the heating element may include an inductive heater, such as induction coil. In some embodiments, the heating element may include a plasma chamber or plasma heater. In some embodiments, the plasma chamber or heater may include a quartz enclosure and induction coils around the quartz enclosure for generating plasma from, e.g., argon or nitrogen, inside the quartz enclosure to form the heating zone 400, 500.

In some embodiments, heating of the intermediate assembly 250 may be carried out such that the outer tube 210, more specifically, the inner surface 216 of the outer tube 210, may become sufficiently softened such that the outer surfaces 228 of the inner tubes 220 may adhere or bond to the inner surface 216 of the outer tube 210. At the same time, heating of the intermediate assembly 250 may be controlled such that the outer tube 210 and/or the inner tubes 220 may not deform, slump, crystallize, or devitrify due to excessive heating (e.g., excessive heating time and/or excessive heating temperature).

In some embodiments, the heating of the intermediate assembly 250 may be carried out such that the inner surface 216 of the outer tube 210 may achieve a viscosity less than or equal to (i.e., ≤) 10⁸ poise, ≤ 5 × 10⁷ poise, ≤ 10⁷ poise, ≤ 5 × 10⁶ poise, or less. In some embodiments, the heating of the intermediate assembly 250 may be carried out such that the viscosity of the inner surface 216 of the outer tube 210 may remain greater than or equal to (i.e., ≥) 10⁶ poise, ≥ 5 × 10⁶ poise, ≥ 10⁷ poise, ≥ 5 × 10⁷ poise, or greater. In some embodiments, the heating of the intermediate assembly 250 may be carried out such that the viscosity of the inner surface 216 of the outer tube 210 may be greater than or equal to (i.e., ≥) 10⁶ poise and less than or equal to (i.e., ≤) 10⁸ poise – including all sub-ranges or values therebetween, such as ≥ 10⁶ poise and ≤ 10⁸ poise, ≥ 10⁷ poise and ≤ 10⁸ poise, or ≥ 10⁷ poise and ≤ 10⁸ poise. In some embodiments, the heating of the intermediate assembly 250 may be carried out such that the outer surface 228 of each inner tube 220 may not be significantly lowered. In some embodiments, the heating of the intermediate assembly 250 may be carried out such that the viscosity of the outer surface 228 of each inner tube 220 may remain greater than or equal to (i.e., ≥) 10⁶ poise, ≥ 10⁷ poise, ≥ 10⁸ poise, or greater.

In some embodiments, the inner surface 216 of the outer tube 210 may be heated to or near the softening point of the material forming the outer tube 210. In some embodiments, the outer tube 210 may be formed of fused silica or quartz glass, and the inner surface 216 of the outer tube 210 may be heated to a temperature greater than or equal to (i.e., ≥) 1500 °C and less than or equal to (i.e., ≤) 1600 °C – including all sub-ranges or values therebetween. For example, in some embodiments, the inner surface 216 of the outer tube 210 may be heated to a temperature ≥ 1500 °C and ≤ 1600 °C, ≥ 1500 °C and ≤ 1550 °C, or ≥ 1550 °C and ≤ 1600 °C. In some embodiments, the inner surface 216 of the outer tube 210 may be heated to a temperature ≥ 1500 °C, ≥ 1510 °C, ≥ 1520 °C, ≥ 1530 °C, ≥ 1540 °C, ≥ 1550 °C, ≥ 1560 °C, ≥ 1570 °C, ≥ 1580 °C, ≥ 1590 °C, or greater. In some embodiment, the inner surface 216 of the outer tube 210 may be heated to a temperature ≤ 1600 °C, ≤ 1590 °C, ≤ 1580 °C, ≤ 1570 °C, ≤ 1560 °C, ≤ 1550 °C, ≤ 1540 °C, ≤ 1530 °C, ≤ 1520 °C, ≤ 1510 °C, or less. Other heating temperature may be implemented depending on the material forming the outer tube 210.

Depending on the thickness of the outer tube 210, the heating time, more specifically, the time duration during which the intermediate assembly 250 or a portion thereof may be exposed to the heating zone 400, 500, may range from seconds (such as in the case of laser or plasma heating) to an hour or more (such as in the case of resistive heating) for the inner surface 216 of the outer tube 210 to be sufficiently softened, depending on the heating methods used. In some embodiments, the heating time may be greater than or equal to (i.e., ≥) 0.5 second and less than or equal to (i.e., ≤) 1 hour – including all sub-ranges or values therebetween, such as ≥ 1 second and ≤ 1 hour, ≥ 1 second and ≤ 30 minutes, ≥ 1 second and ≤ 15 minutes, ≥ 1 second and ≤ 30 seconds, ≥ 30 seconds and ≤ 1 hour, ≥ 30 seconds and ≤ 30 minutes, ≥ 30 seconds and ≤ 15 minutes, ≥ 15 minutes and ≤ 1 hour, ≥ 15 minutes and ≤ 30 minutes, or ≥ 30 minutes and ≤ 1 hour.

Once the inner surface 216 of the outer tube 210 is heated to become sufficiently softened, the outer surfaces 228 of the inner tubes 220 may attach or bond to the inner surface 216 of the outer tube 210 along a greater portion or the entirety of the length of each inner tube 220 to form the hollow-core preform 200, and the hollow-core preform 200 may be removed from the heating zone 400, 500 and cooled. In some embodiments, the fixture may also be removed from the hollow-core preform 200.

In some embodiments, while the intermediate assembly 250 may be heated in the heating zone 400, 500, axial tension may be imparted to the intermediate assembly 250 to facilitate the attachment or bonding between the inner tubes 220 and the outer tube 210. The axial tension may be imparted to the inner tubes 220, the outer tube 210, or both. In some embodiments, the axial tension may be imparted to the inner tubes 220 and/or the outer tube 210 due to gravity when the intermediate assembly 250 may be vertically oriented. In some embodiments, additional axial pulling force may be applied to the inner tubes 220 and/or outer tube 210.

The axial tension, whether due to gravity and/or additional axial pulling force applied, may promote the attachment or bonding between the inner tubes 220 and the outer tube 210 in the heating zone 400, 500. Without intending to be bound by theory, the axial tension imparted on the outer tube 210 may cause the outer tube 210 to elongate slightly and/or may cause the inner diameter of the outer tube 210 to reduce (or neck down) slightly. Additionally, without intending to be bound by theory, the axial tension imparted on the outer tube 210 and/or the inner tubes 220 may reduce or remove unevenness in the inner surface 216 of the outer tube 210 and/or the outer surfaces 228 of the inner tubes 220. The reduced inner diameter of the outer tube 210 and/or the reduced unevenness in the inner surface 216 of the outer tube 210 and/or the outer surfaces 228 of the inner tubes 220 may reduce or eliminate any gaps or spaces at the interface of the inner tubes 220 and the outer tube 210, thereby promoting the attachment or bonding between the inner tubes 220 and the outer tube 210.

It should be noted that during heating, whether with or without additional axial pulling force applied, significant necking of either the inner tube 220 or the outer tube 210 may not occur, and thus, attachment or bonding between the inner tubes 220 and the outer tube 210 may be formed without significant change or reduction in the thicknesses of the inner tubes 220 and/or the outer tube 210 when the hollow-core preform 200 may be formed. In the hollow-core preform 200 formed using the process described herein, the reduction in the thicknesses of the inner tubes 220 and/or the outer tube 210, when referenced to their respective thicknesses prior to heating, may be less than or equal to (i.e., ≤) 50%, ≤ 25%, ≤ 10 %, ≤ 9 %, ≤ 8 %, ≤ 7 %, ≤ 6 %, ≤ 5 %, ≤ 4 %, ≤ 3 %, ≤ 2 %, ≤ 1 %, ≤ 0.5 %, ≤ 0.1 %, or less. In some embodiments, the heating time and/or temperature may be controlled such that no change or reduction in the thicknesses of the inner tubes 220 and/or the outer tube 210 may occur when forming the hollow-core preform 200.

In some embodiments, as an alternative or in addition to heating the intermediate assembly 250 in a furnace having a heating zone 400, 500, the inner tubes 220 may be further attached to the outer tube 210 by laser welding using, e.g., a carbon monoxide (CO) laser, carbon dioxide (CO₂) laser, a yttrium based laser, such as a rare-earth-doped yttrium based laser (e.g., neodymium-doped yttrium aluminum garnet (YAG) laser, or any other suitable laser. The laser may be selected or configured such that heating by the laser can be focused near and/or at the interface of the inner tubes 220 and the outer tube 210 for attaching the inner tubes 220 to the outer tube 210. For example, depending on the particular dimensions of the hollow-core preform, a carbon monoxide (CO) laser may be used due to its greater penetration in silica glass before heating such that the laser may penetrate the outer tube 210 to achieve more localized or focused heating near or at the interface of the inner tubes 220 and the outer tube 210. Additional exemplary lasers and processes for laser welding are described in US Patent Publication No. 2023/0040327 and U.S. Patent Publication No. US2014/0199519, the contents of which are incorporated herein by reference in their entireties.

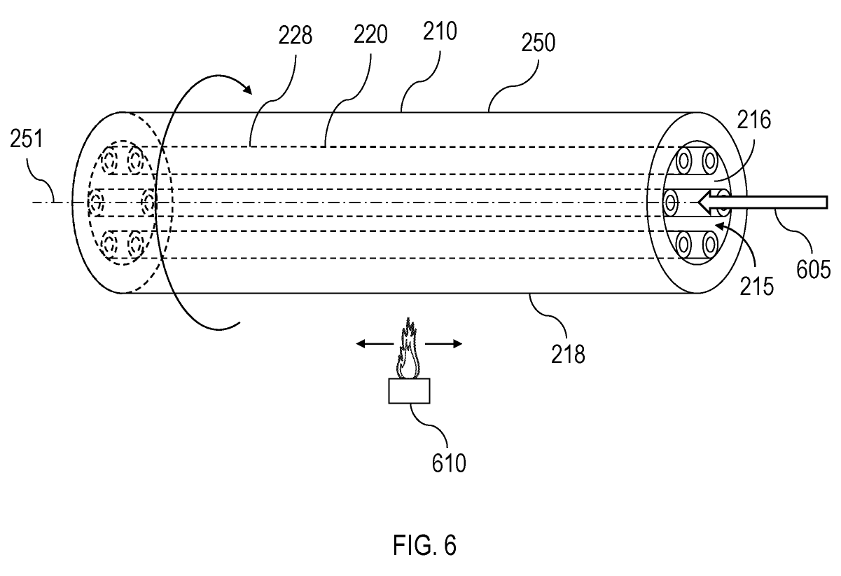

FIG. 6 schematically illustrates another exemplary process for forming a hollow-core preform, such as the hollow-core preform 200. The process may include gathering the inner tubes 220 inside the interior cavity 215 of the outer tube 210 and securing the inner tubes 220 to the inner surface 216 of the outer tube 210 near or at the ends of the inner tubes 220 to form an intermediate assembly 250. The inner tubes 220 may be secured to the outer tube 210 at either end of each inner tube 220 in a manner the same as or similar to that described above with reference to FIGS. 3 and 4 (e.g., using a fixture, laser welding, flame welding, etc.) and thus, not repeated. Depending on the manner in which the inner tubes 220 may be secured to the outer tube 210 to form the intermediate assembly 250, the outer surfaces 228 of the inner tubes 220 may directly contacts and/or may be in close proximity to the inner surface 216 of the outer tube 210 along the length of the inner tubes 220.

In some embodiments, the process shown in FIG. 6 may include flowing one or more glass precursors 605 into the interior cavity 215 of the outer tube 210 for forming soot particles, such as silica-containing glass soot particles. In some embodiments, the silica-containing glass soot particles may include silicon carbide (SiC), silicon monoxide (SiO), silicon nitride (Si₃N₄), silica (SiO₂), etc. In some embodiments, the one or more glass precursors 605 may include silicon halides, such as silicon tetrafluoride (SiF₄), silicon tetrabromide (SiBr₄), silicon tetrachloride (SiCl₄), silicon tetraiodide (SiI₄), etc. The one or more glass precursors 605 may additionally contain one or more dopants, such as germanium or fluorine, or other modifiers and/or additives. In some embodiments, prior to flowing the one or more glass precursors 605, the opening at either end of each inner tube 220 may be sealed.

The process may further include heating the outer tube 210 and/or the inner tubes 220 to facilitate the formation of the soot particles. In some embodiments, a heating element 610 may be disposed around the exterior of the outer tube 210 and configured to heat the outer surface 218 of the outer tube 210. In some embodiments, the heating element 610 may include a flame heater (such as shown in FIG. 6) configured to move along the lengths of the outer tube 210 and/or the inner tubes 220. In some embodiments, the intermediate assembly 250 may be rotated about its longitudinal axis 251, for example, by a pair of support members at either end of the intermediate assembly 250 for rotating the intermediate assembly 250. In some embodiments, the ends of the outer tube 210 may be held by the support members which may be configured to rotate, thereby rotating the intermediate assembly 250 about its longitudinal axis 251.

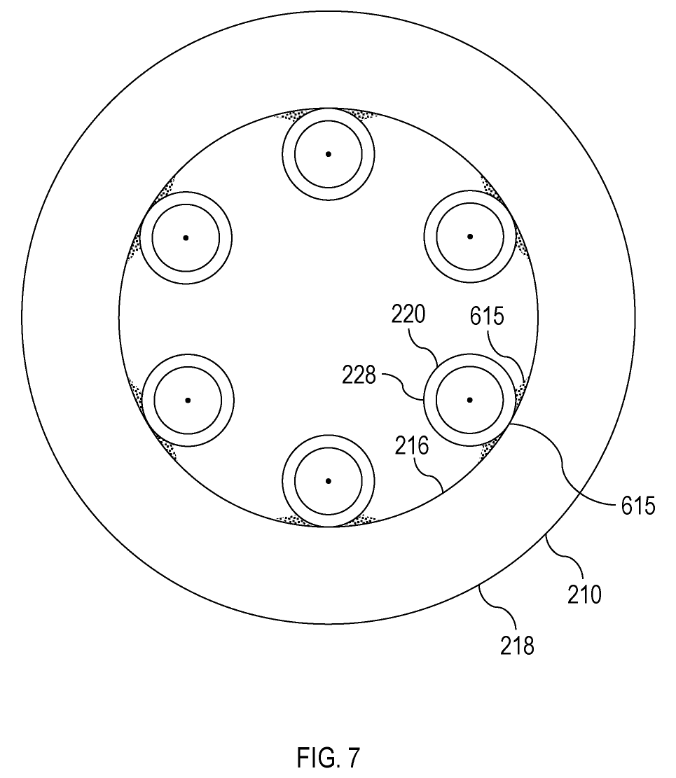

As heat is being applied to the outer surface 218 of the outer tube 210, the inner surface 216 of the outer tube 210 and/or the portion of the outer surface 228 of each inner tube 220 that may be in direct contact with or in close proximity to the outer surface 218 of the outer tube 210 may also be heated, causing the one or more glass precursors 605 to form soot particle deposition 615 therebetween as shown in FIG. 7. The soot particle deposition 615 may accumulate on either side of the direct contact formed between the outer surfaces 228 of the inner tubes 220 and the inner surface 216 of the outer tube 210. In some embodiments, when the inner tubes 220 may not directly contact the inner surface 216 of the outer tube 210 due to the manners in which the ends of the inner tubes 220 may be secured to the outer tube 210, manufacturing variances, etc., the soot particle deposition 615 may also accumulate between the gaps or spaces between the inner tubes 220 and the outer tube 210 and forming the attachment or bonding therebetween.

In some embodiments, the heating element 610 may be configured to produce a heating zone similar to the heating zone 400, 500 discussed above with reference to FIGS. 3 and 5. Similarly, in some embodiments, the heating element 610 may include a resistive heater, such as a resistive graphite cylinder or crucible, an inductive heater, such as induction coil, a plasma chamber or plasma heater, etc., as discussed above with reference to FIGS. 3 and 5. However, it should be noted that to form the soot particle deposition 615, the inner surface 216 of the outer tube 210 and/or the outer surfaces 228 of the inner tubes 220 may not need to be heated to or near the softening point of the materials forming the outer tube 210 and/or the inner tubes 220. Thus, in some embodiments, the inner surface 216 of the outer tube 210 and/or the outer surfaces 228 of the inner tubes 220 may be heated to a temperature sufficient to facilitate the formation of the soot particle deposition 615 but may not cause the materials forming the inner tubes 220 and/or the outer tube 210 to soften, deform, or melt.

In some embodiments, in the process as shown in FIG. 6, the heating element 610 may be configured to heat the inner surface 216 of the outer tube 210 and/or the portion of the outer surface 228 of each inner tube 220 in direct contact with or in close proximity to the inner surface 216 of the outer tube 210 to or near the softening point of the materials forming the inner tubes 220 and/or the outer tube 210 as discussed above. Thus, the inner tubes 220 and the outer tube 210 may be attached or bonded to each other by both the soot particle deposition 615 and/or direct bonding between the inner tubes 220 and the outer tube 210.

In some embodiments, the heating element 610 may be configured to heat the inner surface 216 of the outer tube 210 and/or the outer surfaces 228 of the inner tubes 220 to a temperature greater than or equal to (i.e., ≥) 1400 °C, ≥ 1450 °C, ≥ 1500 °C, ≥ 1550 °C, or greater. In some embodiments, the heating element 610 may be configured to heat the inner surface 216 of the outer tube 210 and/or the outer surfaces 228 of the inner tubes 220 to a temperature less than or equal to (i.e., ≤) 1600 °C, ≤ 1550 °C, ≤ 1500 °C, ≤ 1450 °C, or less. In some embodiments, the heating element 610 may be configured to heat the inner surface 216 of the outer tube 210 and/or the outer surfaces 228 of the inner tubes 220 to a temperature greater than or equal to (i.e., ≥) 1400 °C and less than or equal to (i.e., ≤) 1600 °C – including all sub-ranges or values therebetween, such as ≥ 1400 °C and ≤ 1500 °C, or ≥ 1500 °C and ≤ 1600 °C.

In some embodiments, the heating time and/or heating temperature may be controlled such that the inner surface 216 of the outer tube 210 and the portions of the outer surfaces 228 of the inner tubes 220 in direct contact or close proximity to the inner surface 216 of the outer tube 210 may be heated to a temperature for deposition of the soot particles, while heat transfer to the portions of the outer surfaces 228 of the inner tubes 220 away from the inner surface 216 of the outer tube 210 (such as the portions of the outer surfaces 228 of the inner tubes 220 facing the longitudinal axis 251 of the intermediate assembly 250) may be limited, thereby limiting the deposition of soot particles on portions of the outer surfaces 228 of the inner tubes 220 away from the outer tube 210. In some embodiments, some soot particles may be deposited on portions of the inner surface 216 of the outer tube 210 extending between adjacent inner tubes 220 and/or portions of the outer surfaces 228 of the inner tubes 220 away from the outer tube 210, the deposition may be limited such that the dimensions of the inner tubes 220 and the outer tube 210 may not be altered significantly to affect subsequent processing and ultimately the dimensions of the hollow-core optical fibers drawn. In some embodiments, the heating element 610 may be configured to apply heat only to portions of the outer surface 218 of the outer tube 210 disposed radially outward from the portions of the inner surface 216 of the outer tube 210 to be attached or bonded to the inner tubes 220 so as to limit or confine the deposition of soot particles near or at the interface of the inner tubes 220 and the outer tube 210.

The movement of the heating element 610 along the length of the inner tube 220 and/or the rotation of the intermediate assembly 250 may affect the formation, flow, and/or deposition rate of the soot particles inside the interior cavity 215 of the outer tube 210 and/or onto the outer surface 228 of each inner tube 220 and/or the inner surface 216 of the outer tube 210. In some embodiments, the heating element 610 may be configured to traverse along portions or the entirety of the length of the inner tube 220 in one pass to achieve desired soot particle deposition 615 for bonding the inner tubes 220 to the outer tube 210. In some embodiments, the heating element 610 may be configured to traverse along portions or the entirety of the length of the inner tube 220 multiple times to accumulate desired soot particle deposition 615 for bonding the inner tubes 220 to the outer tube 210.

In some embodiments, to further facilitate and/or enhance the bonding or attaching of the inner tubes 220 to the outer tube 210, axial tension may be imparted to the intermediate assembly 250 to facilitate the attachment or bonding between the inner tubes 220 and the outer tube 210 by, e.g., orienting the intermediate assembly 250 vertically and/or applying additional axial force, similar to how axial tension may be imparted during the process described above with reference to FIGS. 3, 4 , and 5. In some embodiments, soot deposition and axial tension may be applied simultaneously. In some embodiments, soot deposition and axial tension may be applied sequentially.

In some embodiments, after bonding the inner tubes 220 to the outer tube 210, the flow of the one or more glass precursors 605 may be stopped, and the process may further include heating the hollow-core preform 200 formed to a temperature higher than that utilized during soot deposition to consolidate the soot particles to form a less porous bond between the inner tubes 220 and the outer tube 210.

In some embodiments, water, such as 18 Mega-Ohm deionized water, may be applied to the interface of the inner tubes 220 and the outer tube 210 to promote adhesion. In some embodiments, after attaching the inner tubes 220 to the outer tube 210, an annealing step may be carried out so as to relieve any stresses that may be induced during the heating and/or cooling steps.

As discussed above, the various processes described herein may attach or bond the inner tubes 220 to the outer tube 210 along a greater portion of the length of each inner tube 220 than mere attachment at or near the ends of the inner tubes 220. In some embodiments, the various processes described herein may attach or bond the inner tubes 220 to the outer tube 210 along the portion of the length of each inner tube 220 between the ends of the inner tubes 220, e.g., the middle portion of the length of each inner tube 220. The various processes described herein may attach or bond the inner tubes 220 to the outer tube 210 continuously along the middle portion of the length of each inner tube 220. In some embodiments, the various processes described herein may attach or bond the inner tubes 220 to the outer tube 210 along a majority of the length of each inner tube 220. The various processes described herein may attach or bond the inner tubes 220 to the outer tube 210 continuously along a majority of the length of each inner tube 220. In some embodiments, the various processes described herein may attach or bond the inner tubes 220 to the outer tube 210 along greater than or equal to (i.e., ≥) 50% of the length of each inner tube 220. For example, in some embodiments, the various processes described herein may attach or bond the inner tubes 220 to the outer tube 210 along ≥ 50%, ≥ 55%, ≥ 60%, ≥ 65%, ≥ 70%, ≥ 75%, ≥ 80%, ≥ 85%, ≥ 90%, ≥ 95%, or ≥ 99% of the length of each inner tube 220. In some embodiments, the various processes described herein may attach or bond the inner tubes 220 to the outer tube 210 continuously along the entire length of each inner tube 220.

As the various processes described herein may attach or bond the inner tubes 220 directly to the outer tube 210, in some embodiments, a radial distance between the inner surface 216 of the inner tube 220 and the outer surface 218 of the outer tube 210 at the location of attachment or bonding may correspond to the thickness of the inner tube 220 and the thickness of the outer tube 210 combined. As discussed above, in some embodiments, axial tension may be imparted on the inner tubes 220 and/or the outer tube 210 which may elongate the inner tubes 220 and/or the outer tube 210 and/or reduce the diameters of the inner tubes 220 and/or the outer tube 210. Thus, in some embodiments, the radial distance between the inner surface 216 of the inner tube 220 and the outer surface 218 of the outer tube 210 at the location of attachment or bonding may be no greater than and may be slightly less than the combined thickness of the inner tube 220 and the outer tube 210. In some embodiments, spaces or gaps may be present prior to bonding or attachment and such spaces or gaps may be filled by, e.g., soot particles. Thus, in some embodiments, the radial distance between the inner surface 216 of the inner tube 220 and the outer surface 218 of the outer tube 210 at the location of attachment or bonding may be slightly greater than the combined thickness of the inner tube 220 and the outer tube 210. Thus, in the various embodiments described herein, the radial distance between the inner surface 216 of the inner tube 220 and the outer surface 218 of the outer tube 210 at the location of attachment or bonding may correspond to or substantially correspond to the thickness of the inner tube 220 and the thickness of the outer tube 210 combined.

In some embodiments, the radial distance between the inner surface 216 of the inner tube 220 and the outer surface 218 of the outer tube 210 at the location of attachment or bonding may be greater than or equal to (i.e., ≥) 50%, ≥ 75%, ≥ 90%, ≥ 91%, ≥ 92%, ≥ 93%, ≥ 94%, ≥ 95%, ≥ 96%, ≥ 97%, ≥ 98%, ≥ 99%, ≥ 99.5% of the combined thickness of the inner tube 220 and the outer tube 210 prior to assembly or bonding. In some embodiments, the radial distance between the inner surface 216 of the inner tube 220 and the outer surface 218 of the outer tube 210 at the location of attachment or bonding may be less than or equal to (i.e., ≤) 120%, ≤ 110%, ≤ 105%, ≤ 103%, ≤ 101%, ≤ 101.5% of the combined thickness of the inner tube 220 and the outer tube 210 prior to assembly or bonding. In some embodiments, the radial distance between the inner surface 216 of the inner tube 220 and the outer surface 218 of the outer tube 210 at the location of attachment or bonding may be less than or equal to (i.e., ≤) 100%, or less than < 100% of the combined thickness of the inner tube 220 and the outer tube 210 prior to assembly or bonding. In some embodiments, the radial distance between the inner surface 216 of the inner tube 220 and the outer surface 218 of the outer tube 210 at the location of attachment or bonding may be greater than or equal to (i.e., ≥) 50% and less than or equal to (i.e., ≤) 120% of the combined thickness of the inner tube 220 and the outer tube 210 prior to assembly or bonding – including all sub-ranges or values therebetween, such as ≥ 75 % and ≤ 110 %, ≥ 90 % and ≤ 105%, or ≥ 95% and ≤ 105% of the combined thickness of the inner tube 220 and the outer tube 210 prior to assembly or bonding. In some embodiments, the radial distance between the inner surface 216 of the inner tube 220 and the outer surface 218 of the outer tube 210 at the location of attachment or bonding may be equal to the combined thickness of inner tube 220 and the outer tube 210 prior to assembly or bonding. In other words, no change or reduction in the respective thicknesses of the inner tube 220 and/or the outer tube 210 may occur prior and subsequent to assembly or bonding.

Although the various processes described herein with reference to a hollow-core preform having an outer tube and one or more inner tubes bonded thereto, it should be noted that the various processes described herein may also be used for attaching a nested tube to an inner tube. In some embodiments, the nested tube may be attached to the inner tube using the various processes described herein prior to placing the bonded the nested and inner tubes inside an outer tube. In some embodiments, the nested tube(s), the inner tube(s), and the outer tube may be assembled together, and then the nest tube may be attached to the inner tube at the same time as the inner tube may be attached to the outer tube using the various processes described herein.

The term hollow-core preform used herein thus may refer to a preform that may be ready for drawing hollow-core optical fibers as will be discussed in more detail below, and such hollow-core preform may also be referred to as a hollow-core optical fiber preform. The term hollow-core preform may also refer to an intermediate preform that may be further processed to produce a hollow-core optical fiber preform prior to fiber drawing. Such intermediate preform may include similar structural configuration to the hollow-core optical fiber preform, and further processing may include lengthening, formation of additional glass material on the outer tube, etc. The term hollow-core preform may also refer to the assembly of a nested tube attached to the inner surface of an inner tube.

By attaching the inner tubes to the outer tube along a greater portion of the length (e.g., more than the ends, along the entire length) of the inner tubes and/or attaching the nested tubes to the inner tubes along a greater portion of the length of the nested tubes, greater bonding strength between the nested tubes, the inner tubes, and the outer tube may be formed, which may limit or prevent the inner tubes from separating from the outer tube and/or limit or prevent the nested tubes from separating from the inner tubes during handling. Additionally, the greater bonding strength may also limit or prevent the inner tubes from separating from the outer tube and/or limit or prevent the nested tubes from separating from the inner tubes during subsequent drawing process, in which the nested tubes and/or the inner tubes may be pushed toward the center of the hollow-core preform in the neck down region. Furthermore, attaching or bonding the inner tubes to the outer tube along a greater portion of the length or the entire length of each inner tube and/or attaching or bonding the nested tubes to the inner tubes along a greater portion of the length or the entire length of each nested tube may anchor the inner tubes and/or the nested tubes and prevent the inner tubes and/or nested tubes from shifting during subsequent drawing process, resulting in improved alignment of the capillaries and/or the nested capillaries of the hollow-core optical fiber drawn.

### Producing Hollow-Core Optical Fiber

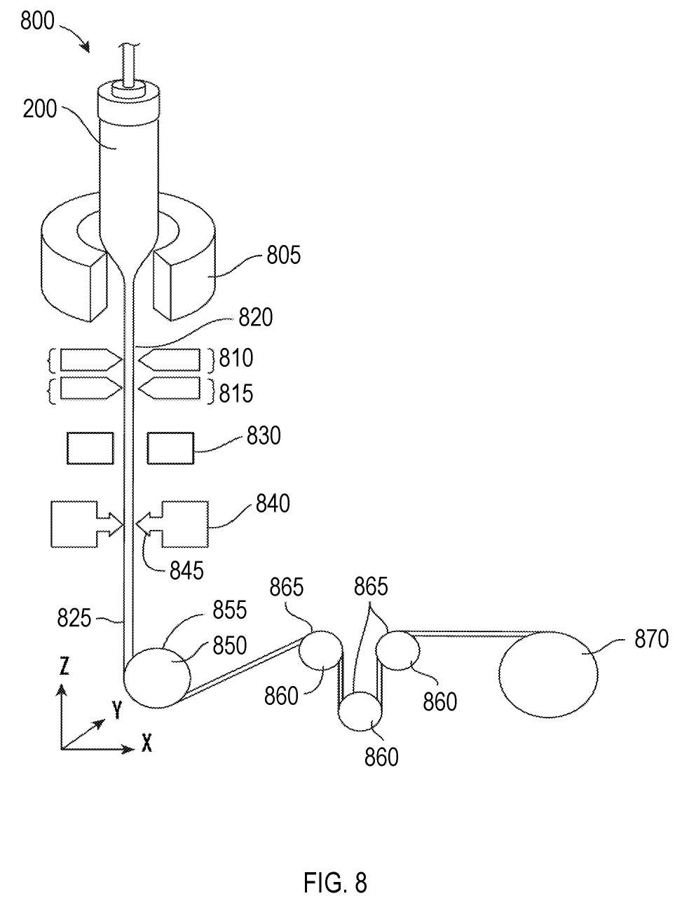

FIG. 8 schematically illustrates an exemplary process 800 for drawing a hollow-core optical fiber from a hollow-core preform, such as hollow-core preform 200. The drawing system 800 may include a furnace 805 for heating the hollow-core preform 200. The furnace 805 may be disposed in a draw tower. In some embodiments, the furnace 805 may include a heater such that the hollow-core preform 200 is heated and drawn into a hollow-core optical fiber 820 as the hollow-core preform 200 is lowered towards the heater.

The drawing system 800 may further include non-contact measurement sensors 810, 815 for measuring the size (e.g., diameter control) of the drawn (bare) hollow-core optical fiber 820 that exits the furnace 805. A cooling station 830 may reside downstream of the measurement sensors 810, 815 and may be configured to cool the bare hollow-core optical fiber 820. A coating station 840 may reside downstream of the cooling station 830 and may be configured to deposit a protective coating material 845 onto the bare hollow-core optical fiber 820 to form a coated fiber 825. A tensioner 850 may reside downstream of the coating station 840. The tensioner 850 may include a surface 855 that pulls (draws) the coated fiber 825. A set of guide wheels 860 with respective surfaces 865 may reside downstream of the tensioner 850. The guide wheels 860 may serve to guide the coated fiber 825 to a fiber take-up spool 870 to store the coated fiber 825.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A hollow-core preform, comprising:
a preform longitudinal axis;
an outer tube disposed around the preform longitudinal axis, the outer tube comprising:
an inner surface defining an interior cavity through which the preform longitudinal axis extends; and
an outer surface; and
an inner tube disposed inside the interior cavity of the outer tube, the inner tube comprising:
an inner tube longitudinal axis offset from the preform longitudinal axis;
an inner surface disposed around the inner tube longitudinal axis;
an outer surface;
a first end;
a second end opposite the first end; and
a length extending between the first end and the second end; and
soot particles;
wherein the outer surface of the inner tube is bonded to the inner surface of the outer tube by the soot particles; and
wherein:
the outer surface of the inner tube directly contacts the inner surface of the outer tube, and the outer surface of the inner tube is bonded to the inner surface of the outer tube on either side of the direct contact by at least some of the soot particles; and/or
at least some of the soot particles are disposed on a portion of the outer surface of the inner tube facing away from the outer tube.

2. The hollow-core preform of claim 1, wherein the outer surface of the inner tube is bonded to the inner surface of the outer tube along the entire length of the inner tube.

3. The hollow-core preform of claim 1, wherein the outer surface of the inner tube is bonded to the inner surface of the outer tube continuously along the entire length of the inner tube.

4. The hollow-core preform of claim 1, wherein the distance between the inner surface of the inner tube and the outer surface of the outer tube at the location of bonding is no greater the thickness of the inner tube and the thickness of the outer tube combined.

5. The hollow-core preform of claim 1, wherein the inner tube is a first inner tube, the hollow-core preform further comprising a second inner tube disposed inside the interior cavity of the outer tube.

6. The hollow-core preform of claim 1, further comprising a nested tube disposed inside an interior cavity of the inner tube.

7. The hollow-core preform of claim 1, wherein the inner surface of the outer tube is continuous around an inner circumference of the outer tube.

8. A hollow-core preform, comprising:
a preform longitudinal axis;
an outer tube disposed around the preform longitudinal axis, the outer tube comprising:
an inner surface defining an interior cavity through which the preform longitudinal axis extends;
an outer surface; and
a thickness defined by a distance between the inner surface and the outer surface that is greater than or equal to 2 mm and less than or equal to 15 mm;
an inner tube disposed inside the interior cavity of the outer tube, the inner tube comprising:
an inner tube longitudinal axis offset from the preform longitudinal axis;
an inner surface disposed around the inner tube longitudinal axis;
an outer surface;
a thickness defined by a distance between the inner surface and the outer surface that is greater than or equal to 0.5 mm and less than or equal to 10 mm;
a first end;
a second end opposite the first end; and
a length extending between the first end and the second end;
wherein the outer surface of the inner tube is bonded directly to the inner surface of the outer tube continuously along a majority of the length of the inner tube; and
wherein a distance between the inner surface of the inner tube and the outer surface of the outer tube at the location of bonding substantially corresponds to the thickness of the inner tube and the thickness of the outer tube combined.

9. A method of making a hollow-core preform, comprising:
providing an outer tube, wherein the outer tube comprises:
an outer tube longitudinal axis;
an inner surface defining an interior cavity through which the outer tube longitudinal axis extends;
an outer surface; and
a thickness defined by a distance between the inner surface and the outer surface;
positioning an inner tube inside the interior cavity of the outer tube, wherein the inner tube comprises:
a first end;
a second end opposite the first end;
a length between the first end and the second end;
an inner tube longitudinal axis extending from the first end to the second end and offset from the outer tube longitudinal axis;
an inner surface disposed around the inner tube longitudinal axis;
an outer surface; and
a thickness defined by a distance between the inner surface and the outer surface;
flowing one or more glass precursors into the interior cavity of the outer tube;
heating the outer tube to cause the one or more glass precursors to form soot particles on at least one of the outer surface of the inner tube or the inner surface of the outer tube.

10. The method of claim 8, wherein the outer surface of the inner tube is bonded to the inner surface of the outer tube by at least some of the soot particles.

11. The method of claim 8, wherein the inner tube is positioned inside the interior cavity of the outer tube such that the outer surface of the inner tube directly contacts or is in proximity to the inner surface of the outer tube along at least a middle portion of the length of the inner tube.

12. The method of claim 8, wherein after the outer surface of the inner tube is bonded to the inner surface of the outer tube, a distance between the inner surface of inner tube and the outer surface of the outer tube at the location of bonding (i) substantially corresponds to a combined thickness of the thickness of the inner tube and the thickness of the outer tube prior to bonding or (ii) is no greater than a combined thickness of the thickness of the inner tube and the thickness of the outer tube prior to bonding.

13. The method of claim 8, wherein the outer surface of the inner tube is bonded to the inner surface of the outer tube along the entire length of the inner tube.

14. The method of claim 8, wherein heating the outer tube comprises applying heat to a portion of the outer tube that is less than an entire length of the outer tube.

15. The method of claim 8, wherein heating the outer tube comprises heating the outer tube using at least one of a laser source, a flame heater, a plasma heater, a resistive heater, or an inductive heater.

16. The method of claim 8, further comprising applying an axial force to at least one of the inner tube or the outer tube.

17. The method of claim 8, further comprising prior to heating the outer tube, bonding the inner tube to the outer tube at or near at least one of the first end or the second end of the inner tube.

18. The method of claim 8, positioning the inner tube inside the interior cavity of the outer tube comprises holding the inner tube inside the interior cavity of the outer tube by a fixture at or near at least one of the first end or the second end of the inner tube.

19. The method of claim 8, wherein the inner tube is a first inner tube, the method further comprising providing a second inner tube inside the interior cavity of the outer tube.

20. The method of claim 8, further comprising providing a nested tube inside an interior cavity of the inner tube.
